(19) United States
(12) Patent Application Publication
(10) Pub. No.: US 2025/0384267 A1
(43) Pub. Date: Dec. 18, 2025

(54) CLUSTERING TECHNIQUES FOR MACHINE LEARNING MODELS

(71) Applicant: EQUIFAX INC., Atlanta, GA (US)

(72) Inventors: Piyush Patel, Peachtree City, GA (US); Dessa Overstreet, Waynesboro, GA (US); Rajkumar Bondugula, Irving, TX (US)

(21) Appl. No.: 19/141,890

(22) PCT Filed: Dec. 23, 2022
(86) PCT No.: PCT/US2022/082377

§ 371 Date: Jun. 20, 2025

(51) Int. Cl. G06N 3/08; G06Q 20/40

(52) U.S. Cl. CPC G06N 3/08; G06Q 20/4016

(57) ABSTRACT

In some aspects, systems and methods for efficiently clustering a large-scale dataset for improving the construction and training of machine-learning models, such as neural network models, are provided. Clustering can include determining a number of clusters to be generated for the dataset. A dataset used for training a neural network model configured can be clustered into a set of clusters. The clustering can include determining the number of clusters, determining special features for the determined number of clusters, and re-clustering the dataset based on the special features. The neural network can be trained based on training samples selected from the set of clusters. In some aspects, the trained neural network model can be utilized to satisfy risk assessment queries to compute output risk indicators for target entities. The output risk indicator can be used to control access to one or more interactive computing environments by the target entities.

### TECHNICAL FIELD

The present disclosure relates generally to artificial intelligence. More specifically, but not by way of limitation, this disclosure relates to building and training machine learning models such as artificial neural networks for predictions or performing other operations.

### BACKGROUND

In machine learning, artificial neural networks can be used to perform one or more functions (e.g., acquiring, processing, analyzing, and understanding various inputs in order to produce an output that includes numerical or symbolic information). A neural network includes one or more algorithms and interconnected nodes that exchange data between one another. The nodes can have numeric weights or other associated parameters that can be tuned, which makes the neural network adaptive and capable of learning. For example, the numeric weights can be used to train the neural network such that the neural network can perform the one or more functions on a set of input variables and produce an output that is associated with the set of input variables. It is difficult, however, to determine the structure of the neural networks, such as the number of nodes in the hidden layers, and the initial values of the weights and other parameters of the neural network. If these parameters are not properly initialized, the training of the neural network can be time-consuming, and the output produced by the neural network can be inaccurate.

### SUMMARY

Various aspects of the present disclosure provide systems and methods for efficiently clustering a large-scale dataset for improving machine learning models such as neural network models. In some examples, a method includes one or more processing devices performing operations. The operations include clustering a dataset into a set of clusters. The clustering comprises: determining a number of clusters to be generated for the dataset; clustering the dataset into the determined number of clusters; determining a plurality of special features for the determined number of clusters; and re-clustering the dataset based on the plurality of special features to generate the set of clusters. The operations further include training a neural network model for computing a risk indicator from predictor variables based on the set of clusters wherein the neural network model is trained based on training samples selected from the set of clusters, the training samples comprising training predictor variables and training outputs corresponding to the training predictor variables; receiving, from a remote computing device, a risk assessment query for a target entity; computing, responsive to the risk assessment query, an output risk indicator for the target entity by applying the trained neural network model to predictor variables associated with the target entity; and transmitting, to the remote computing device, a responsive message including the output risk indicator, wherein the output risk indicator is usable for controlling access to one or more interactive computing environments by the target entity.

In another example, a system includes a processing device and a memory device in which instructions executable by the processing device are stored for causing the processing device to perform operations. The operations include clustering a dataset into a set of clusters. The clustering includes determining a number of clusters to be generated for the dataset; clustering the dataset into the determined number of clusters; determining a plurality of special features for the determined number of clusters; and re-clustering the dataset based on the plurality of special features to generate the set of clusters. The operations further include training a neural network model for computing a risk indicator from predictor variables based on the set of clusters. The neural network model is trained based on training samples selected from the set of clusters, the training samples comprising training predictor variables and training outputs corresponding to the training predictor variables. The operations further include computing, responsive to a risk assessment query, an output risk indicator for a target entity by applying the trained neural network model to predictor variables associated with the target entity.

In another example, a non-transitory computer-readable storage medium includes program code that is executable by a processor device to cause a computing device to perform operations. The operations include clustering a dataset into a set of clusters. The clustering comprises: determining a number of clusters to be generated for the dataset; clustering the dataset into the determined number of clusters; determining a plurality of special features for the determined number of clusters; and re-clustering the dataset based on the plurality of special features to generate the set of clusters. The operations further include training a neural network model for computing a risk indicator from predictor variables based on the set of clusters. The neural network model is trained based on training samples selected from the set of clusters, the training samples comprising training predictor variables and training outputs corresponding to the training predictor variables. The operations further include computing, responsive to a risk assessment query, an output risk indicator for a target entity by applying the trained neural network model to predictor variables associated with the target entity; and transmitting to a remote computing device, a responsive message including the output risk indicator.

### BRIEF DESCRIPTION OF THE DRAWINGS

The foregoing, together with other features and examples, will become more apparent upon referring to the following specification, claims, and accompanying drawings.

FIG. 1 is a block diagram depicting an example of an operating environment in which clustering is used to build and train a machine learning model for risk prediction according to certain aspects of the present disclosure.

FIG. 2 is a flow chart depicting an example of a process for utilizing a neural network to generate risk indicators for a target entity based on predictor variables associated with the target entity according to certain aspects of the present disclosure.

FIG. 3 is a flow chart depicting an example of a process for clustering risk data according to certain aspects of the present disclosure.

FIG. 4 is a flow chart depicting an example of a process for determining the number of clusters for a set of data, according to certain aspects of the present disclosure.

FIG. 5 is a flow chart depicting an example of a process for determining special features of clusters for a set of data, according to certain aspects of the present disclosure.

FIG. 6 is a diagram depicting an example of a separation between centroids for a pair of clusters according to certain aspects of the present disclosure.

FIG. 7 is a block diagram depicting an example of a computing system suitable for implementing aspects of the techniques and technologies presented herein.

### DETAILED DESCRIPTION

Some aspects of the disclosure relate to efficiently clustering a large-scale dataset into multiple clusters that can be used for improving machine learning models such as neural network models. An example of a large-scale dataset is one that includes 200 million points of data, with each point of data having hundreds of features. A clustering process according to some examples presented herein can significantly reduce computational complexity of processing the large-scale dataset while improving the quality of the clustered dataset.

The clustering process can involve an iterative splitting process in which the splitting starts with the dataset. In each iteration, a cluster is selected and split into two and the cluster centroids can be calculated and adjusted. Clustering techniques such as K-means clustering can be used to cluster the data in the dataset according to the cluster centroids. The clustering process can continue until certain termination conditions are satisfied.

In one example, the clustering process can also involve determining an optimized number of clusters for a set of data. Based on a maximum cluster size value, a set of quartiles can be produced. An algorithm can be applied to the set of quartiles to determine the optimized number of clusters. The algorithm can be automatically modified based on a size of the set of data, the maximum cluster size, or the number of clusters in each quartile. The optimized number of clusters can be determined. The set of data can be grouped into the optimized number of clusters.

In some examples, the clustering process can involve performing a statistical analysis on the clusters. The statistical analysis can include determining cluster statistics of the cluster features, such as the minimum, maximum, averages and standard deviations. A portion of the clusters can be selected based on the statistical analysis to include the clusters that are outliers compared to other clusters. For example, the portion of clusters can include clusters with features that deviate from the averages by at least one standard deviation.

Particular clusters with special features can be identified from the portion of the clusters by further investigating features of clusters within the portion of the clusters. For example, special features can be defined as features of a particular cluster that deviate from a cluster average by at least two standard deviations. In some examples, the special features can be defined based on a comparison of clusters within the portion of clusters. For instance, the special features can be defined as features of the particular cluster that deviate at least one standard deviation from an average of the portion of the clusters for that feature. The special features can be the main features that lead to the clustering results. In other words, the special features are the distinguishing features that cause data to be clustered in their respective clusters. These special features can be utilized to re-cluster the set of data to achieve a more accurate clustering result. As such, the clustering process can involve multiple iterations of determining special features and re-clustering based on the special features.

In some examples, the statistical analysis can further include determining centroids of each cluster in the portion of clusters. A separation between centroids for each pair of clusters in the portion of clusters can be calculated. Pairs of clusters can be grouped into nearest neighbors or furthest neighbors based on the calculated separations. The nearest neighbors or the furthest neighbors can be used as criteria of an additional re-clustering process. The additional re-clustering process can involve multiple iterations of splitting clusters and the nearest neighbors or furthest neighbors can be selected to be split. The iterations can continue until a minimum or maximum separation between pairs of clusters is met.

In one example, a set of data used for training a neural network model, such as a neural network model configured for computing a risk indicator, can be clustered into a first set of clusters and a second set of clusters with a finer granularity using the clustering described herein. As such, the number of clusters in the second set of clusters is higher than the number of clusters in the first set of clusters. The first set of clusters can be utilized to determine the structure of the neural network model, such as the number of nodes in the hidden layers. The second set of clusters can be utilized to determine the training samples for the neural network model from a large set of data.

For example, the training samples can be generated by taking a number of samples from each of the clusters in the second set, where the number of samples taken from each cluster is proportional to the size of that cluster. In this way, the training samples are representative of the data contained in the dataset. The training samples can include training predictor variables and training outputs corresponding to the predictor variables. The neural network model can be constructed to include a number of nodes in a hidden layer that is equal to the number of clusters in the first set of clusters.

In some aspects, the trained neural network model can be utilized to satisfy risk assessment queries. For example, for a risk assessment query for a target entity, an output risk indicator for the target entity can be computed by applying the trained neural network model to predictor variables associated with the target entity. The output risk indicator can be used to control access to one or more interactive computing environments by the target entity.

As described herein, certain aspects provide improvements to machine learning by providing data-driven construction and training of the machine learning models. The data used by the neural network model is analyzed through clustering to facilitate the determination of the structure and initial settings of the neural network model. Compared with traditional model construction based on randomly initializing the structure of the neural network, the technology presented herein helps to select a network structure that matches the training data. Selecting a network structure that matches the training data can optimize or otherwise improve the performance of the neural network (e.g., the accuracy of precision of its outputs) and significantly reduce computing resource consumption involved in the training of the neural network. In addition, since the training data samples are selected based on the clusters, the training samples are representative of the data contained in the dataset thereby increasing the prediction accuracy of the neural network.

In addition, by determining an optimized number of clusters, the number of clusters can be controlled to avoid the number of clusters getting too large. This reduces the complexity of the machine learning model and the size of the training data, thereby reducing the computational resource consumption (e.g., CPU time, memory size, etc.). The statistical analysis of the clusters can further improve the prediction accuracy. For example, the special features that lead to the clustering results as identified through the statistical analysis can be used to re-cluster the data to generate more accurate clustering results, thereby resulting in a machine learning model with a higher accuracy. Further, the clustering mechanism proposed herein, and thus the neural network structure determined based on the clustering, is based on a deterministic process and the results can be reproduced and traced if needed.

Additional or alternative aspects can implement or apply rules of a particular type that improve existing technological processes involving machine-learning techniques. For instance, to determine the clusters of the dataset for building and training the neural network, a particular set of rules are employed to ensure the efficient and accurate clustering, such as the rules for determining the number of clusters, rules for identifying special feature, and rules for re-clustering based on the identified special features. This particular set of rules allows the clustering to be performed more efficiently and accurately, thereby ensuring the accuracy and efficiency of the building and training of the neural network model.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

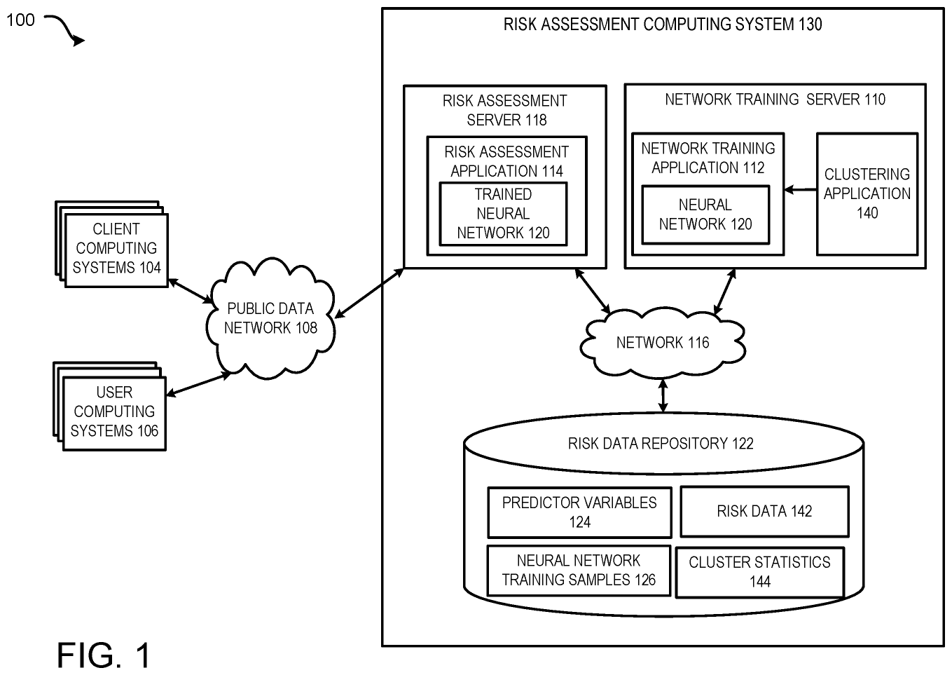

FIG. 1 is a block diagram depicting an example of an operating environment 100 where the clustering is used to build and train a machine learning model for risk prediction. In this operating environment, a risk assessment computing system 130 builds and trains a neural network 120 that can be utilized to predict risk indicators of various entities based on predictor variables 124 associated with the respective entity. FIG. 1 depicts examples of hardware components of a risk assessment computing system 130, according to some aspects. The risk assessment computing system 130 is a specialized computing system that may be used for processing large amounts of data using a large number of computer processing cycles. The risk assessment computing system 130 can include a network training server 110 for building and training a neural network 120 for predicting risk indicators. The risk assessment computing system 130 can further include a risk assessment server 118 for performing risk assessment for given predictor variables 124 using the trained neural network 120.

The network training server 110 can include one or more processing devices that execute program code, such as a network training application 112 or a clustering application 140. The program code is stored on a non-transitory computer-readable medium. The network training application 112 can execute one or more processes to train and optimize a neural network 120 for predicting risk indicators based on predictor variables 124.

In some examples, the network training application 112 can build and train a neural network 120 utilizing neural network training samples 126. The neural network training samples 126 can include multiple training vectors consisting of training predictor variables and training risk indicator outputs corresponding to the training vectors. The neural network training samples 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the network training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory or memory devices.

In some examples, the neural network training samples 126 can be generated from risk data 142 associated with various entities, such as users or organizations. The risk data 142 can include attributes of each of the entities. For example, the risk data 142 can include R rows and N columns for R entities, each row representing an entity and each column representing an attribute (also referred to herein as feature) of the entity, wherein R and N are positive integer numbers. The risk data for each entity can also be represented as a vector with N elements/attributes. In some scenarios, the risk data 142 includes a large-scale data set, such as 200 million rows or vectors and each row/vector having more than 1000 attributes. The risk data 142 can also be stored in the risk data repository 122.

To generate the neural network training samples 126, the network training server 110 can execute a clustering application 140 configured for clustering data into multiple clusters. The neural network training samples 126 can be generated by clustering the risk data 142 into multiple clusters so that each data mode is represented by a cluster. As used herein, the data mode refers to the underlying characteristics of the data vectors or data points. A large data set might contain a large number of data modes. Randomly sampling this large data set without clustering might not capture all the data modes. Clustering the data set into clusters can help to group data with similar data modes together. As a result, sampling the data set by taking samples from each of the clusters can increase the chances of the sampled data points covering all the data modes. Therefore, the neural network training samples 126 can be generated by taking samples from each of the clusters that are proportional to the respective sizes of the clusters. In this way, the neural network training samples 126 are more representative of the data modes contained in the risk data 142 and the representation of a data mode is proportional to the size of that data mode.

In addition, or alternatively, the network training server 110 can also execute the clustering application 140 to determine the structure of the neural network 120 and initial settings of the neural network 120. For instance, the network training server 110 can execute the clustering application 140 to group the risk data 142 into multiple clusters, each cluster representing one segment of entities. The clustering in this example might be performed at a lower level of granularity than that of the clustering mentioned above for the generation of neural network training samples 126. The number of clusters can be used to set the number of nodes in the first hidden layer of a neural network 120.

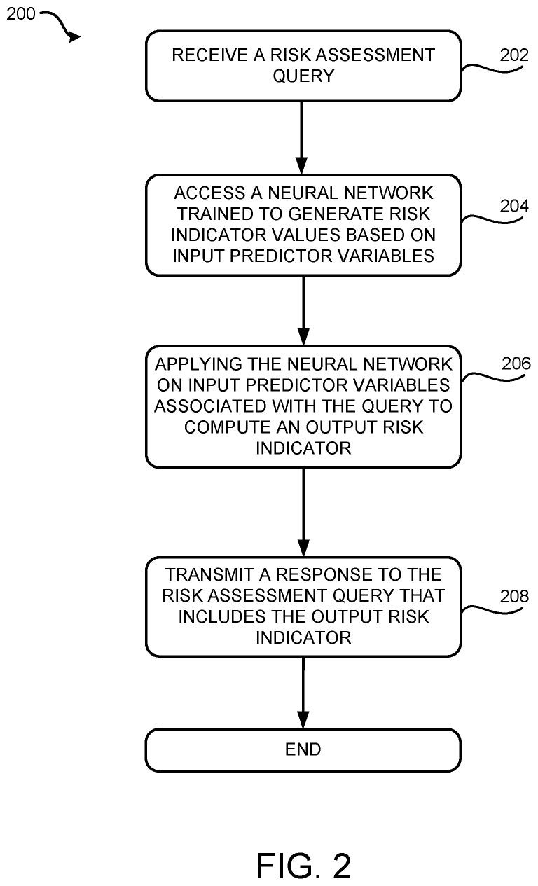

Further, the data points in each of these clusters (which may be sampled in a way similar to that described above with respect to the generation of the neural network training samples 126) can be used to train a logistic model to determine the parameters of the logistic model. The parameters of these trained logistic models can be used to initialize the weights of the paths from the input layer to the first hidden layer of the neural network 120. The network training server 110 can further train the neural network 120 by freezing the weights and biases between the input layer and the first hidden layer to learn the rest of the parameters of the neural network 120. In another example, the weights and biases of additional hidden layers and the output layer of the neural network can be obtained similarly. For instance, the outputs of a previous hidden layer can be clustered using the clustering technologies presented herein. The number of generated clusters can be utilized to set the number of nodes in the current hidden layer. Each of the clusters can be used to train a logistic regression model. The parameters of the trained logistic regression models can be used to set or initialize the weights and biases associated with the nodes in the current hidden layer. Additional details regarding determining configurations of a neural network based on clustering are provided with regard to FIG. 2.

Note that while FIG. 1 and the above description show that the clustering application 140 is executed by the network training server 110, the clustering application 140 can be executed on another device separate from the network training server 110. The risk assessment server 118 can include one or more processing devices that execute program code, such as a risk assessment application 114. The program code is stored on a non-transitory computer-readable medium. The risk assessment application 114 can execute one or more processes to utilize the neural network 120 trained by the network training application 112 to predict risk indicators based on input predictor variables 124.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate electronic transactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the mobile device 102 and the client computing system 104 to be performed.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. 1 can configure a neural network to be used for accurately determining risk indicators, such as credit scores, using predictor variables. A predictor variable can be any variable predictive of risk that is associated with an entity. Any suitable predictor variable that is authorized for use by an appropriate legal or regulatory framework may be used.

Examples of predictor variables used for predicting the risk associated with an entity accessing online resources include, but are not limited to, variables indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity, and so on.), variables indicative of one or more behavioral traits of an entity (e.g., the timeliness of the entity releasing the online resources), etc. Similarly, examples of predictor variables used for predicting the risk associated with an entity accessing services provided by a financial institute include, but are not limited to, indicative of one or more demographic characteristics of an entity (e.g., age, gender, income, etc.), variables indicative of prior actions or transactions involving the entity (e.g., information that can be obtained from credit files or records, financial records, consumer records, or other data about the activities or characteristics of the entity), variables indicative of one or more behavioral traits of an entity, etc.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The numbers of devices depicted in FIG. 1 are provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the network training server 110 and the risk assessment server 118, may be instead implemented in a signal device or system.

FIG. 2 is a flow chart depicting an example of a process 200 for utilizing a neural network to generate risk indicators for a target entity based on predictor variables associated with the target entity. At operation 202, the process 200 involves receiving a risk assessment query for a target entity from a remote computing device, such as a computing device associated with the target entity requesting the risk assessment. The risk assessment query can also be received from a remote computing device associated with an entity authorized to request risk assessment of the target entity.

At operation 204, the process 200 involves accessing a neural network trained to generate risk indicator values based on input predictor variables or other data suitable for assessing risks associated with an entity. Examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The risk indicator can indicate a level of risk associated with the entity, such as a credit score of the entity.

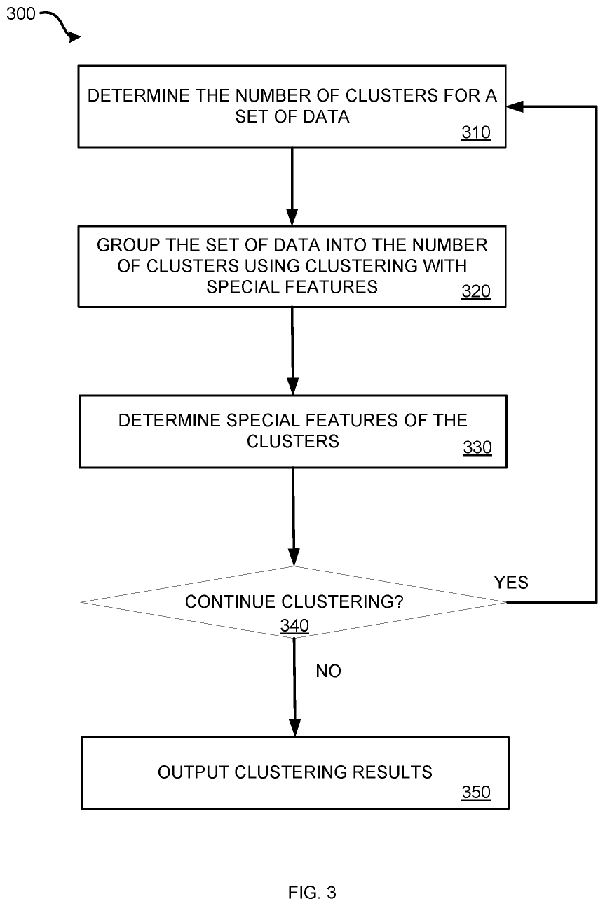

The neural network can be constructed and trained using training samples generated based on clustering the risk data 142 as described above. In some examples, the neural network 120 includes an input layer having N nodes each corresponding to a training predictor variable in an N-dimension input predictor vector. The neural network 120 further includes a hidden layer having M nodes and an output layer containing one or more outputs. The number of nodes in the hidden layer, M, can be determined based on the number of clusters generated by clustering the risk data 142 into user segments. In order to generate the neural network training samples 126, the clustering application 140 can further cluster the risk data 142 into clusters with a higher level of granularity. Sample data can be selected from each of the finer clusters in proportion to the size of the respective cluster. For example, one out of every 100 samples can be selected from each cluster in order to generate a set of neural network training samples 126 that has a size of 1% of the risk data 142. Neural network training samples 126 with other sizes can be generated similarly. Additional details regarding clustering the risk data 142 will be presented below with regard to FIGS. 3-6.

Depending on the type of the neural network 120, training algorithms such as backpropagation can be used to train the neural network 120 based on the generated neural network training samples 126. In some examples, the neural network training samples 126 can be grouped according to the user segments as discussed above which can be used to determine the number of hidden nodes in the hidden layer. These groups of neural network training samples 126 can each be used to train a separate logistic regression model. The parameters of the trained logistic regression models can be utilized to determine the weights and biases between the input layer and the hidden layer. The network training server 110 can further train the neural network model by freezing these determined weights and biases and learning the remaining parameters.

In other examples, the neural network can have more than one hidden layer. The number of nodes and the weight and bias associated with each node in each hidden layer can be determined in a similar way. For example, the number of nodes in the first hidden layer and the associated weights and biases can be determined as described above. For the second hidden layer, the outputs of the first hidden layer can be clustered and the number of clusters can be used to determine the number of nodes in the second hidden layer. Likewise, the outputs of the first hidden layer in each cluster can be utilized to train a separate logistic regression model. The parameters of these logistic regression models can be utilized to determine the weights and biases associated with the nodes in the second hidden layer. This process can be repeated for any number of hidden layers.

The weights and biases for the output layer can also be determined similarly. For example, the outputs of the last hidden layer can be clustered according to the number of nodes in the output layer. The outputs in each cluster can be utilized to train a corresponding logistic regression model. The parameters of these logistic regression models can be utilized to determine the weights and biases associated with the nodes in the output layer. Alternatively, or additionally, the weights and biases associated with the nodes in the output layer can be obtained using any neural network training method. The training can be performed by fixing the weights of the hidden layers to be the estimated weights and determining the weights and biases for the output layer. In other examples, the training can be performed by using the estimated weights for the hidden and output layers as the initial weights and the training can return optimized weights for all the layers.

At operation 206, the process 200 involves applying the neural network to generate a risk indicator for the target entity specified in the risk assessment query. Predictor variables associated with the target entity can be used as inputs to the neural network. The predictor variables associated with the target entity can be obtained from a predictor variable database configured to store predictor variables associated with various entities. The output of the neural network would include the risk indicator for the target entity based on its current predictor variables.

At operation 208, the process 200 involves generating and transmitting a response to the risk assessment query and the response can include the risk indicator generated using the neural network. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with banks, credit unions, credit-card companies, insurance companies, or other financial institutions and be implemented to provide interactive computing environments for customers to access various services offered by these institutions. Customers can utilize user computing systems 106 to access the interactive computing environments thereby accessing the services provided by the financial institution.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate predictor variables. The risk assessment server 118 can perform a risk assessment based on predictor variables generated for the customer and return the predicted risk indicator to the client computing system 104.

Based on the received risk indicator, the client computing system 104 can determine whether to grant the customer access to the interactive computing environment. If the client computing system 104 determines that the level of risk associated with the customer accessing the interactive computing environment and the associated financial service is too high, the client computing system 104 can deny access by the customer to the interactive computing environment. Conversely, if the client computing system 104 determines that the level of risk associated with the customer is acceptable, the client computing system 104 can grant the access to the interactive computing environment by the customer and the customer would be able to utilize the various financial services provided by the financial institutions. For example, with the granted access, the customer can utilize the user computing system 106 to access web pages or other user interfaces provided by the client computing system 104 to query data, submit online digital application, operate electronic tools, or perform various other operations within the interactive computing environment hosted by the client computing system 104.

Referring now to FIG. 3, a flow chart depicting an example of a process 300 for clustering risk data 142 is presented. One or more computing devices (e.g., the network training server 110) implement operations depicted in FIG. 3 by executing suitable program code (e.g., the clustering application 140). For illustrative purposes, the process 300 is described with reference to certain examples depicted in the figures. Other implementations, however, are possible.

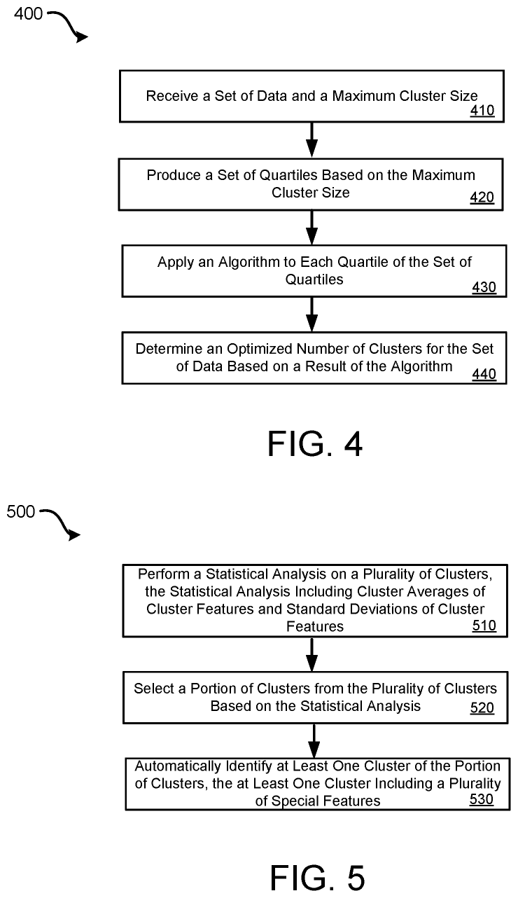

At block 310, the process 300 involves determining the number of clusters to be generated for a set of data. In some scenarios, the number of clusters can be determined while performing the clustering, such as when the clustering converges. In other scenarios, however, the clustering process does not lead to a desired number of clusters. For example, the clustering does not converge or converges too late leading to a large number of clusters being generated diminishing the benefits achieved by using the clustering. Therefore, it can be useful to limit the number of clusters within a certain range depending on the application and an optimized number of clusters can be determined from within that range. The optimized number of clusters can be determined according to certain metrics and constraints. An example of determining the number of clusters for the set of data is shown in FIG. 4 which will be described in detail below.

At block 320, the process 300 involves grouping the set of data into the determined number of clusters using clustering techniques such as high dimensional clustering or other clustering techniques based on special features. Grouping the set of data into the number of clusters can involve selecting an existing cluster for splitting. If there is only one existing cluster (such as at the beginning of the clustering process), this one cluster is selected for splitting. If there is more than one existing cluster, a splitting criterion can be utilized to determine which cluster is to be selected for splitting. For example, the splitting criterion can be configured to select the largest cluster (i.e., containing the largest number of data points) among the existing clusters for splitting. In another example, the splitting criterion can be configured to select the widest cluster among the existing clusters for splitting. The width of a cluster can be measured by the radius of the cluster having the largest radius is the widest cluster. In some examples, the radius of a cluster is defined as the largest distance or the average distance between the centroid of the cluster and a data point in the cluster.

Grouping the set of data into the number of clusters can further involve splitting the selected cluster into two clusters by picking two initial cluster points from the selected cluster. The first cluster point can be selected as the data point farthest from the centroid of the cluster. The second cluster point can be selected as the data point farthest from the first cluster point. Once the two initial cluster points are selected, two new clusters can be formed. In particular, the first cluster can be formed by including data points that are closer to the first cluster point and the second cluster can be formed by including data points that are closer to the second cluster point.

After splitting the cluster based on the two initial cluster points, the cluster centroids can be iteratively adjusted. The updated cluster centroids can, in turn, be utilized to re-cluster the data points into two clusters. This process can continue until the centroids for the two new clusters become stable. This process can be continued until the determined number of clusters are obtained. In some examples, the clustering is performed utilizing the special features of the set of data and ignoring other features of the data. If special features have not been identified, all the features of the data are used for clustering. Additional details about clustering the set of data are provided in U.S. Pat. No. 11,475,235 entitled “Clustering Techniques for Machine Learning Models” issued Oct. 18, 2022, the entirety of which is hereby incorporated by reference. Other clustering techniques may also be used to group the set of data into the determined number of clusters.

At block 330, the process 300 involves determining special features of the clusters. As discussed above, the special features can be the main features that lead to the clustering results. In other words, the special features are the distinguishing features that cause data to be clustered in their respective clusters. For example, special features can be determined as features of a particular cluster that deviate from a cluster average by at least two standard deviations. An example of determining the special features of the clusters is shown in FIG. 5, which is described below.

At block 340, the process 300 involves determining whether clustering of the set of data should be terminated. The conditions for terminating the clustering can include, for example, a maximum number of iterations has been reached or a maximum number of clusters has been generated. In some examples, the conditions for terminating the clustering can include an identification of a maximum number of particular clusters having a plurality of special features as described in the FIG. 5 description below. The conditions for terminating the clustering can also include identifying a threshold amount of nearest neighbors or furthest neighbors as defined in the FIG. 5 description below. In some examples, the clustering should be terminated if all the clusters have at least a predetermined number of samples. This termination condition can ensure that the clusters are not over split into clusters smaller than expected.

If none of the termination conditions is satisfied, the process 300 continues to perform the next round of clustering (i.e., re-clustering) by starting with determining the number of clusters for the set of data based on the special features at block 310. If at least one of the termination conditions is satisfied, the process terminates the clustering, and at block 350, involves outputting clustering results. In some examples, outputting the clustering results can include providing a narrative for the at least one cluster to a client based on the special features.

As discussed above, the clustering results can be used to determine the number of user segments, thereby determining the number of hidden nodes in the hidden layer of the neural network 120. The determined user segments can also be used to build other types of models that are used for the prediction, such as logistic regression models. One logistic regression model can be built for one user segment.

To generate the neural network training samples 126, the clustering algorithm can be executed to generate finer clusters (e.g., 100 segments) to increase the representativeness of the underlying data modes by each cluster. A pre-determined amount of random samples (e.g., 1%) can be selected from each cluster to form the neural network training samples 126.

FIG. 4 is a flow chart depicting an example of a process 400 for optimizing the number of clusters for a set of data. One or more computing devices (e.g., the network training server 110) implement operations depicted in FIG. 4 by executing suitable program code (e.g., the clustering application 140). For illustrative purposes, the process 400 is described with reference to certain examples depicted in the figures. Other implementations, however, are possible.

At block 410, the process 400 involves receiving a set of data and a maximum cluster size. In some examples, the maximum cluster size can be user defined and received from a user computing system 106. In some examples, criteria for optimizing the number of clusters can be received. The criteria can include, for example, a maximum number of data points in any single cluster. At block 420, the process 400 involves producing a set of regions (e.g., quartiles) based on the maximum cluster size. For instance, if the set of regions is a set of quartiles, the set of quartiles for a maximum cluster size of 5000 can include a first quartile with cluster numbers in a range of 2-1200, a second quartile with cluster numbers in a range of 1201-2500, a third quartile with cluster numbers between 2501-3700, and a fourth quartile with cluster numbers between 3701-5000. Other ways of producing the set of regions can be utilized, such as dividing the range between 2 and the maximum cluster size N into p regions with p being equal to or higher than two. The different regions may have the same length or different lengths.

In some examples, a truncating integer division method can be used to determine the p regions. The truncating integer division method can involve distributing the maximum cluster size N into p regions. The division method can involve calculating “truncating integer division” of N divided by p as well as a corresponding remainder r.

$$d = [ \frac{n}{p} ]$$

$$r = n mod p = n - pd$$

where n is N−1 (since cluster levels begin at 2) and both n and p are assumed to be strictly positive integers. Then,

$$N = p d + r = r ( d + 1 ) + ( p - r ) d$$

So that a partition of the maximum cluster size into p regions, sizes of each of the p regions can be described as:

$$d + 1 , … , d + 1 , d , … , d$$

where d+1 is repeated r times and d is repeated p−r times. In some implementations, a default value for p is set to 4, but other number of regions can also be used. In additional examples, the number of regions is determined such that there are at least 10 clusters in each region.

At block 430, the process 400 can involve applying an algorithm to each region of the set of regions. The algorithm can determine parameters of each region including a smallest cluster size, an average cluster size, a median cluster size, an average radius of clusters, or a percentage of the set of data included in a maximum cluster size. The algorithm can be automatically modified based on the size of the set of data, the maximum cluster size, and/or the number of clusters in each region.

The algorithm can involve evaluating clustering results for each possible number of clusters in each region to determine the quality of the clustering. For example, Dunn index can be calculated for each possible number of clusters and used to evaluate the cluster results. The Dunn index can be calculated as:

$${DI}_{m} = \frac{{min}_{1 \leq i < j \leq m} δ ( {C}_{i} , {C}_{j} )}{{max}_{1 \leq k \leq m} {Δ}_{k}}$$

Here, m is the number of clusters, δ(Cᵢ, Cⱼ) is the inter-cluster distance between clusters Cᵢ and Cⱼ. Δₖ is the size of cluster Cₖ. A higher Dunn index indicates a better clustering (i.e., well separated compact clusters). A lower Dunn index, on the other hand, indicates a poorer clustering. The above standard Dunn index is generated from the most pessimistic view of the clustering quality because it considers the minimum inter-cluster distance and the maximum cluster size. For many purposes, the worst view is too extreme since the worst clusters can be discarded for many applications and only data that falls in well-defined clusters are used. As such, it might not be an accurate indicator of the quality of the clustering.

Alternatively, or additionally, a modified Dunn Index can be computed using median cluster compactness and median separation. The modified Dunn index can be formulated as:

$$Modified Dunn Index = \frac{{Median}_{1 \leq i \leq j \leq m} δ ( {C}_{i} , {C}_{j} )}{{Median}_{1 \leq k \leq m} {Δ}_{k}}$$

The modified Dunn index can provide a better insight into the clustering quality. It should be understood that the median is used herein only as an example for modifying the Dunn index and should not be construed as limiting. Various other ways to modify the Dunn index to achieve a balance between the pessimistic and optimistic view of the current clustering quality. Each way to modify the Dunn index can be referred to as a Dunn index family. Examples of Dunn index families include a 50/50 Dunn index family, a 25/75 Dunn index family, a 10/90 Dunn index family, etc. The 50/50 Dunn index family represents ratio of median cluster compactness (inter-cluster distance) and median separation (intra-cluster distance). The 25/75 Dunn index family represents a ratio of a 25^{th} percentile of the inter-cluster distances to a 75^{th} percentile of the intra-cluster distances. Different Dunn index families can be applied for each region of the set of regions.

In some examples, the algorithm can involve applying multiple Dunn index families to each region and for each applied Dunn index family, determining if a rate of change for the Dunn index family is increasing or decreasing. Additionally, the algorithm can involve calculating an average rate of change, a count of increasing rates of change, and average Dunn index for the multiple Dunn index families to assess aggregate and relative behavior for an entirety of the Dunn index families, excluding a regular Dunn index family.

For example, the rates of change (ROC) for each Dunn Index family level L and an indicator IROC indicating whether the rate of change is increasing can be calculated as follows, for L=2 to N:

$$ROC {10}_{L} : Rate of Change\_ 10 \_ 90 = \frac{\begin{matrix}Current cluster DunnIndex\_ 10 \_ 90 - \\ Last cluster DunnIndex\_ 10 \_ 90\end{matrix}}{Last cluster DunnIndex\_ 10 \_ 90}$$

$$IROC 10 : If ROC 10 >= 0 then 1 else 0$$

$$ROC {25}_{L} : Rate of Change\_ 25 \_ 75 = \frac{\begin{matrix}Current cluster DunnIndex\_ 25 \_ 75 - \\ Last cluster DunnIndex\_ 25 \_ 75\end{matrix}}{Last cluster DunnIndex\_ 25 \_ 75}$$

$$IROC 25 : If ROC 25 >= 0 then 1 else 0$$

$$ROC {50}_{L} : Rate of Change\_ 50 \_ 50 = \frac{\begin{matrix}Current cluster DunnIndex\_ 50 \_ 50 - \\ Last cluster DunnIndex\_ 50 \_ 50\end{matrix}}{Last cluster DunnIndex\_ 50 \_ 50}$$

$$IROC 50 : If ROC 50 >= 0 then 1 else 0$$

In some examples, the average rate of change (AROC), count of increasing rates of change (IROC) and average Dunn Index (ADI) for each Dunn Index family level (L) can be calculated to assess aggregate and relative behavior for entire Dunn Index Family excluding punitively strict regular Dunn Index.

$${AROC}_{L} : Average\_rate \_of \_change = Average ( Rate\_Of \_Change \_ 10 \_ 90 , \\ Rate\_Of \_Change \_ 25 \_ 75 , Rate\_Of \_Change \_ 50 \_ 50 )$$

$${Number\_IROC}_{L} = Sum ( IROC 10 , IROC 25 , IROC 50 )$$

$${ADI}_{L} : Average ( DunnIndex\_ 10 \_ 90 , DunnIndex\_ 25 \_ 75 , DunnIndex\_ 50 \_ 50 )$$

At block 440, the process 400 involves determining an optimized number of clusters for the set of data based on a result of the algorithm. For instance, a top three cluster recommendations can be provided for each region. The top three cluster recommendations can be determined by, for example, ranking the cluster numbers in each region by values of the average rate of change, the count of increasing rates of changes, or the average Dunn index for the multiple Dunn index families. Among the top three cluster recommendation, a top overall cluster number can also be recommended. The top overall cluster number can be determined by determining a cluster number with the maximum average rate of change from among the top three cluster recommendations from the regions. The output of the top overall cluster number can include maximum and minimum data points in clusters and the minimum and maximum cluster radius for each level. In some examples, the optimized number can be modified based on criteria received from the user.

FIG. 5 is a flow chart depicting an example of a process for determining special features of clusters for a set of data. One or more computing devices (e.g., the network training server 110) implement operations depicted in FIG. 5 by executing suitable program code (e.g., the clustering application 140). For illustrative purposes, the process 500 is described with reference to certain examples depicted in the figures. Other implementations, however, are possible.

At block 510, the process 500 involves performing a statistical analysis on a plurality of clusters. The statistical analysis can include calculating cluster statistics such as the minimum of cluster features, the maximum of the cluster features, cluster averages of cluster features and standard deviations of cluster features. The cluster statistics can also include intra cluster statistics, such as a number of data points in each cluster, a centroid for each cluster, or a minimum and a maximum for each feature. In some examples, the process can involve normalizing features for each cluster in order to enable a comparison between clusters.

At block 520, the process 500 can involve selecting a portion of clusters from the plurality of clusters based on the statistical analysis. For example, each cluster of the portion of clusters can be selected based on a comparison between an average feature value for the cluster and an average feature value of all clusters for that feature. For instance, each cluster of the portion of clusters can be selected based on the average feature value for the cluster deviating from the average of all clusters for the feature by more than at least one standard deviation for the feature.

At block 530, the process 500 involves automatically identifying at least one cluster of the portion of clusters that include special features. The at least one cluster with special features can be identified from the portion of the clusters by further investigating features of clusters within the portion of the clusters. For example, special features can be defined as features of the at least one cluster that deviate from respective cluster averages of the features by at least two standard deviations. In some examples, the special features can be defined based on a comparison of clusters within the portion of clusters. For instance, the special features can be defined by features of the at least one cluster that deviate at least one standard deviation from an average of the portion of the clusters for that feature. Multiple special features can be identified in parallel for each of the at least one cluster of the portion of clusters.

For example, a Z score can be calculated for each feature used in the clustering, with

$$Z = \frac{feature - {m}_{feature}}{s t {d}_{feature}} ,$$

where m_{feature} is the mean of the feature and std_{feature} is the standard deviation of the feature. A high value of Z (e.g., higher than a threshold value) indicates that the features is a distinguishing feature compared to other features used in the clustering and may be identified as a special feature. In other examples, a multi-stage special feature identification may be employed. For instance, in the first stage, non-special features may be filtered out by examining the Z scores of the features and removing features with Z scores lower than a threshold. In the second stage, multiple statistics may be calculated for each of the remaining feature and used to determine special features. Alternatively, or additionally, the statistical analysis discussed above may be applied to a combination of multiple features to determine the special features in the second stage. Because the first stage filters out the majority of features, the number of features in the second stage is significantly smaller thereby significantly reducing the computational complexity of the process.

In some examples, the process 500 can involve discarding a subset of clusters from the portion of clusters based on a plurality of special features associated with the subset.

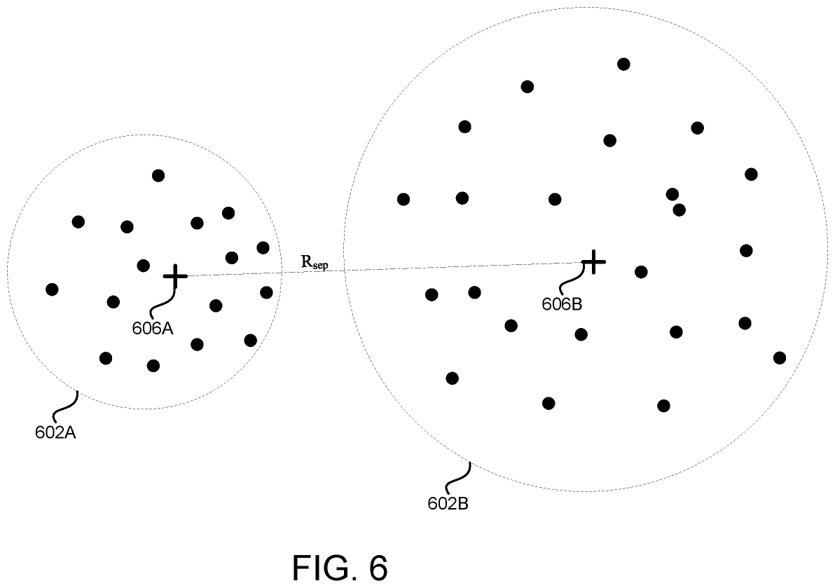

FIG. 6 is a diagram depicting an example of a separation between centroids for a pair of clusters according to certain aspects of the present disclosure. The example includes a first cluster 602A of the pair of clusters and a second cluster 602B of the pair of clusters. The first cluster 602A includes a centroid 606A and the second cluster 602B includes a centroid 606B. A separation between centroid 606A and centroid 606B is depicted in FIG. 6 by Rₛₑₚ.

In some examples, the process 500, described in FIG. 5, involves determining a centroid for each cluster in the portion of clusters. The process 500 can also involve calculating a separation between centroids for each pair of clusters in the portion of clusters. Additionally, the pairs of clusters can be grouped into a plurality of nearest neighbors or a plurality of furthest neighbors. Nearest neighbors (or furthest neighbors) can be identified based on determining that a separation between centroids for two neighbors is less than (greater than) a threshold value for the separation between centroids.

It should be understood that while the above description focuses on using data clustering to facilitate the building and training of the neural network 120 for risk prediction. The clustering presented herein can be applied to various other applications. For example, the clustering can be utilized to estimate missing attribute values in a data set. The missing attribute value of a data point in a cluster can be imputed based on neighbor points that have a value for that attribute. The neighbor points can be defined as other data points in the cluster. The clustering algorithm presented above can also be modified such that the distance between two data points can be computed even if some attributes are not available (e.g., use only attributes available in both data points). In further examples, a minimum number of overlapping attributes is required between a neighbor point and the data point. Similarly, a minimum similarity can be required for a data point to be considered a neighbor of the data point with the missing attribute value. The imputed value can be calculated as the average, weighted average, median or other statistics of the values of the nearest neighbor points.

The clustering mechanism presented herein can also be used to identify micro-segment so that users within a micro-segment can be treated similarly. For instance, recommendations made to a user, such as recommendations for content presentation or resource allocation, can be made to other users in the same micro-segment as this user. The micro-segments can be identified by setting a large number of clusters (e.g., 5000) for the splitting process. Additional conditions can be added when determining which cluster to split in each iteration. For example, if the radius of a cluster is less than a minimum radius (i.e., a very tight cluster), the cluster will not be selected for splitting. If the size of a cluster (i.e., the number of points in the cluster) is less than a minimum size, the cluster will not be selected for splitting. In some implementations, the minimum size of a cluster can be set to be less than the size of the desired micro-segments.

### Example of Computing System

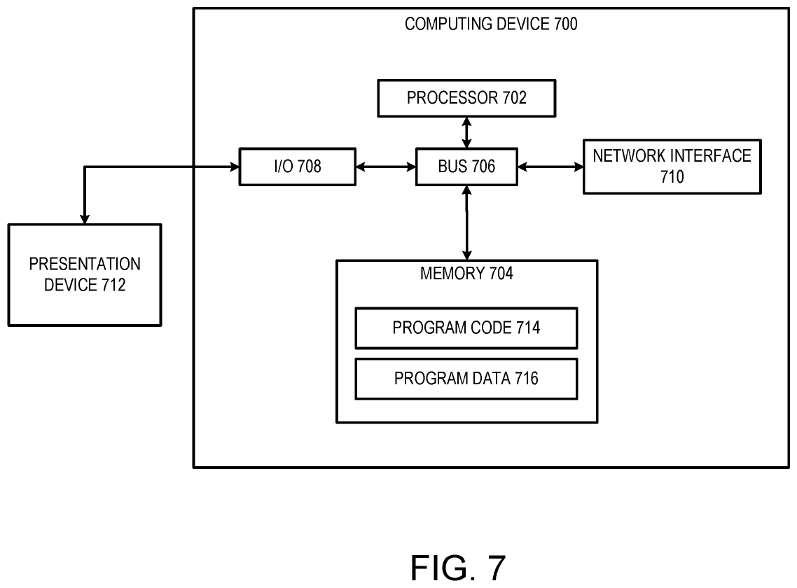

Any suitable computing system or group of computing systems can be used to perform the operations for the machine-learning operations described herein. For example, FIG. 7 is a block diagram depicting an example of a computing device 700, which can be used to implement the risk assessment server 118. The computing device 700 can include various devices for communicating with other devices in the operating environment 100, as described with respect to FIG. 1. The computing device 700 can include various devices for performing one or more clustering (or other suitable) operations described above with respect to FIGS. 1-6.

The computing device 700 can include a processor 702 that is communicatively coupled to a memory 704. The processor 702 can execute computer-executable program code stored in the memory 704, can access information stored in the memory 704, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 702 can include a microprocessor, an application-specific integrated circuit (ASIC), a field-programmable gate array (FPGA), or any other suitable processing device. The processor 702 can include any suitable number of processing devices, including one. The processor 702 can include or communicate with a memory 804. The memory 704 can store program code that, when executed by the processor 802, causes the processor 702 to perform the operations described herein.

The memory 704 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Scala, Hadoop SQL, C, C++, C #, Visual Basic, Java, Python, Perl, JavaScript, ActionScript, etc.

The computing device 700 may also include a number of external or internal devices such as input or output devices. For example, the computing device 700 is illustrated with an input/output interface 708 that can receive input from input devices or provide output to output devices. A bus 706 can also be included in the computing device 700. The bus 706 can communicatively couple one or more components of the computing device 700.

The computing device 700 can execute program code 714 that includes the risk assessment application 114. The program code 714 for the risk assessment application 114 may be resident in any suitable computer-readable medium and may be executed on any suitable processing device. For example, as depicted in FIG. 7, the program code 714 for the risk assessment application 114 can reside in the memory 704 at the computing device 700 along with the program data 716 associated with the program code 714, such as the predictor variables 124. Executing the risk assessment application 114 can configure the processor 702 to perform the operations described herein.

In some aspects, the computing device 700 can include one or more output devices. One example of an output device can be the network interface device 710 depicted in FIG. 7. A network interface device 710 can include any device or group of devices suitable for establishing a wired or wireless data connection to one or more data networks described herein. Non-limiting examples of the network interface device 710 can include an Ethernet network adapter, a modem, etc.

Another example of an output device can include the presentation device 712 depicted in FIG. 7. A presentation device 712 can include any device or group of devices suitable for providing visual, auditory, or other suitable sensory output. Non-limiting examples of the presentation device 712 can include a touchscreen, a monitor, a speaker, a separate mobile computing device, etc. In some aspects, the presentation device 712 can include a remote client-computing device that communicates with the computing device 700 using one or more data networks described herein. In other aspects, the presentation device 712 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A method that includes one or more processing devices performing operations comprising:
clustering a dataset into a set of clusters, wherein the clustering comprises:
determining a number of clusters to be generated for the dataset;
clustering the dataset into the determined number of clusters;
determining a plurality of special features for the determined number of clusters; and
re-clustering the dataset based on the plurality of special features to generate the set of clusters;
training a neural network model for computing a risk indicator from predictor variables based on the set of clusters wherein the neural network model is trained based on training samples selected from the set of clusters, the training samples comprising training predictor variables and training outputs corresponding to the training predictor variables;
receiving, from a remote computing device, a risk assessment query for a target entity;
computing, responsive to the risk assessment query, an output risk indicator for the target entity by applying the trained neural network model to predictor variables associated with the target entity; and
transmitting, to the remote computing device, a responsive message including the output risk indicator, wherein the output risk indicator is usable for controlling access to one or more interactive computing environments by the target entity.

2. The method of claim 1, wherein determining the number of clusters to be generated for the dataset comprises:
producing a set of quartiles of cluster sizes based on a maximum cluster size; applying an algorithm to each quartile of the set of quartiles, the algorithm automatically modified based on one or more of a size of the dataset, the maximum cluster size, or a number of clusters in each quartile; and
determining an optimized number of clusters for the dataset based on a result of the algorithm.

3. The method of claim 1, wherein determining a plurality of special features for the determined number of clusters comprises:
performing a statistical analysis on the set of clusters, the statistical analysis comprising calculating one or more minimum of cluster features, maximum of the cluster features, cluster averages of the cluster features and standard deviations for the cluster features;
selecting a portion of clusters from the set of clusters based on the statistical analysis; and
automatically identifying at least one cluster of the portion of clusters, the at least one cluster comprising a plurality of special features, each special feature identified based on a comparison of values of each special feature for the at least one cluster to the cluster average for each special feature.

4. The method of claim 3, wherein the values of each special feature deviate from the cluster average for each special feature by at least two standard deviations.

5. The method of claim 3, wherein selecting the portion of clusters comprises selecting the portion of clusters based on a feature in the portion of clusters deviating from the cluster average for the feature by at least one standard deviation.

6. The method of claim 3, further comprising providing a narrative for the at least one cluster to a client based on the plurality of special features.

7. The method of claim 3, wherein performing the statistical analysis further comprises:
determining a centroid for each cluster in the portion of clusters;
calculating a separation between centroids for each pair of clusters in the portion of clusters; and
grouping the pairs of clusters into a plurality of nearest neighbors or a plurality of furthest neighbors based on the calculated separations.

8. The method of claim 1, further comprising clustering the dataset into a second set of clusters, wherein a number of clusters in the second set of clusters is lower than the number of clusters in the set of clusters and wherein training the neural network model further comprises setting a hidden layer of the neural network model to have an equal number of nodes as the number of clusters in the second set of clusters.

9. A system comprising:
a processing device; and
a memory device in which instructions executable by the processing device are stored for causing the processing device to perform operations comprising:
clustering a dataset into a set of clusters, wherein the clustering comprises:
determining a number of clusters to be generated for the dataset;
clustering the dataset into the determined number of clusters;
determining a plurality of special features for the determined number of clusters; and
re-clustering the dataset based on the plurality of special features to generate the set of clusters;
training a neural network model for computing a risk indicator from predictor variables based on the set of clusters, wherein the neural network model is trained based on training samples selected from the set of clusters, the training samples comprising training predictor variables and training outputs corresponding to the training predictor variables; and
computing, responsive to a risk assessment query, an output risk indicator for a target entity by applying the trained neural network model to predictor variables associated with the target entity.

10. The system of claim 9, wherein determining the number of clusters to be generated for the dataset comprises:
producing a set of quartiles of cluster sizes based on a maximum cluster size;
applying an algorithm to each quartile of the set of quartiles, the algorithm automatically modified based on one or more of a size of the dataset, the maximum cluster size, or a number of clusters in each quartile; and
determining an optimized number of clusters for the dataset based on a result of the algorithm.

11. The system of claim 9, wherein determining a plurality of special features for the determined number of clusters comprises:
performing a statistical analysis on the set of clusters, the statistical analysis comprising calculating one or more minimum of cluster features, maximum of the cluster features, cluster averages of the cluster features and standard deviations for the cluster features;
selecting a portion of clusters from the set of clusters based on the statistical analysis; and
automatically identifying at least one cluster of the portion of clusters, the at least one cluster comprising a plurality of special features, each special feature identified based on a comparison of values of each special feature for the at least one cluster to the cluster average for each special feature.

12. The system of claim 11, wherein the values of each special feature deviate from the cluster average for each special feature by at least two standard deviations.

13. The system of claim 11, wherein selecting the portion of clusters comprises selecting the portion of clusters based on a feature in the portion of clusters deviating from the cluster average for the feature by at least one standard deviation.

14. The system of claim 11, wherein the instructions further comprise providing a narrative for the at least one cluster to a client based on the plurality of special features.

15. The system of claim 11, wherein performing the statistical analysis further comprises:
determining a centroid for each cluster in the portion of clusters;
calculating a separation between centroids for each pair of clusters in the portion of clusters; and
grouping the pairs of clusters into a plurality of nearest neighbors or a plurality of furthest neighbors based on the calculated separations.

16. The system of claim 11, wherein determining the plurality of special features for the determined number of clusters further comprises causing at least one action to be taken based on the identification of the at least one cluster of the portion of clusters.

17. The system of claim 9, wherein the instructions further comprise clustering the dataset into a second set of clusters, wherein a number of clusters in the second set of clusters is lower than the number of clusters in the set of clusters and wherein training the neural network model further comprises setting a hidden layer of the neural network model to have an equal number of nodes as the number of clusters in the second set of clusters.

18. A non-transitory computer-readable storage medium having program code that is executable by a processor device to cause a computing device to perform operations, the operations comprising:
clustering a dataset into a set of clusters, wherein the clustering comprises:
determining a number of clusters to be generated for the dataset;
clustering the dataset into the determined number of clusters;
determining a plurality of special features for the determined number of clusters; and
re-clustering the dataset based on the plurality of special features to generate the set of clusters;
training a neural network model for computing a risk indicator from predictor variables based on the set of clusters, wherein the neural network model is trained based on training samples selected from the set of clusters, the training samples comprising training predictor variables and training outputs corresponding to the training predictor variables;
computing, responsive to a risk assessment query, an output risk indicator for a target entity by applying the trained neural network model to predictor variables associated with the target entity; and
transmitting to a remote computing device, a responsive message including the output risk indicator.

19. The non-transitory computer-readable storage medium of claim 18, wherein determining the number of clusters to be generated for the dataset comprises:
producing a set of quartiles of cluster sizes based on a maximum cluster size; applying an algorithm to each quartile of the set of quartiles, the algorithm automatically modified based on one or more of a size of the dataset, the maximum cluster size, or a number of clusters in each quartile; and
determining an optimized number of clusters for the dataset based on a result of the algorithm.

20. The non-transitory computer-readable storage medium of claim 18, wherein determining a plurality of special features for the determined number of clusters comprises:
performing a statistical analysis on the set of clusters, the statistical analysis comprising calculating one or more minimum of cluster features, maximum of the cluster features, cluster averages of the cluster features and standard deviations for the cluster features;
selecting a portion of clusters from the plurality of clusters based on the statistical analysis; and
automatically identifying at least one cluster of the portion of clusters, the at least one cluster comprising a plurality of special features, each feature identified based on a comparison of values of each special feature for the at least one cluster to the cluster average for each special feature.
